(19) United States
(12) Patent Application Publication
(10) Pub. No.: US 2019/0023394 A1
(43) Pub. Date: Jan. 24, 2019

(54) UAV Anchoring System

(71) Applicant: Toky Ranaivoson Ranaivoson, Ottawa (CA)

(72) Inventor: Toky Ranaivoson Ranaivoson, Ottawa (CA)

(21) Appl. No.: 15/658,384

(22) Filed: Jul. 24, 2017

(51) Int. Cl. B64C 39/02

(52) U.S. Cl. CPC B64C 39/022; B64C 39/024

(57) ABSTRACT

The UAV Anchor System is an anchoring system used to anchor a UAV to the ground. This system is primarily for beginners who has little to no experience in flying UAVs. The system anchor's the UAV to the ground which prevents the UAV to fly away and crash from a high altitude and also prevent from flying into objects, obstruction, people, traffic, etc. With this system, the user can safely practice with the flying exercises as per instructed in the manual. Once the user properly learns the mechanism of the UAV, the user can take off the anchor system and fly the UAV freely.

Also, because of the anchoring system, the user does not have to fly the UAV in a large field but can do it in a much smaller area which is more convenient for the user such as a backyard or front yard. This system can also be beneficiary for intermediate flyers as they can use this system and practice flying in high winds and let beginners fly their UAV with minimal risk of damage.

### FIELD OF INVENTION

The present invention relates to the UAV industry, for recreational and commercial use.

### SUMMERY OF INVENTION

The invention comprises of an eyelet anchor, a carabiner clip, a double looped rope and an eyelet stake.

The eyelet anchor is attached at the bottom of the UAV. The user then plants the stake into the ground, then loops the rope thru the eyelet. Then, the user loops one loop of the rope thru the other loop and fastens the rope. The other loop of the rope which is free is then clipped onto the carabiner clip and lastly the carabiner clip clips on the eyelet anchor placed at the bottom of the UAV.

The invention is a beginner's tool to learn how to fly a UAV safely, with the guarantee the UAV will not crash from a high altitude and will be clear of any objects including people. Also, with the invention, the user does not have to go to a large field but can even safely fly the anchored flying the UAV in a backyard, front yard or closest public park without being a danger to themselves or the public. Once the user is comfortable flying the UAV with the anchor, the user can then take the anchor system off and fly the UAV freely.

### BRIEF DESCRIPTIONS OF THE DRAWINGS

The drawings are not necessarily to scale, with the emphasis instead placed upon the principals of the invention. Additionally, each of the parts depicted is but a number of possible arrangements utilizing the fundamental concepts of the present invention. FIG. 9 is the UAV Anchoring System complete with all 5 separate pieces put together including the UAV, eyelet anchor, carabiner clip, double looped rope, and eyelet stake.

### DETAILED DESCRIPTION OF THE DRAWINGS

FIG. 1: The UAV. The UVA depicted in the drawing is just one type of UVA the UVA Anchoring System can be used on. No matter what type of UAV, the invention can be applied to as long as the eyelet anchor can be mounted at the bottom of the UVA no matter what type of UAV and any make, model, or design of the UAV.

FIG. 2: The eyelet anchor attached to the UAV. The eyelet anchor which can be a separate piece from the UAV is mounted at the bottom of the UAV. The eyelet anchor's purpose in the present invention is for the carabiner clip to clip onto the eyelet to anchor the UAV. If the user does not have the carabiner clip handy, the user can opt to fasten the double looped rope or tie a knot to the eyelet anchor

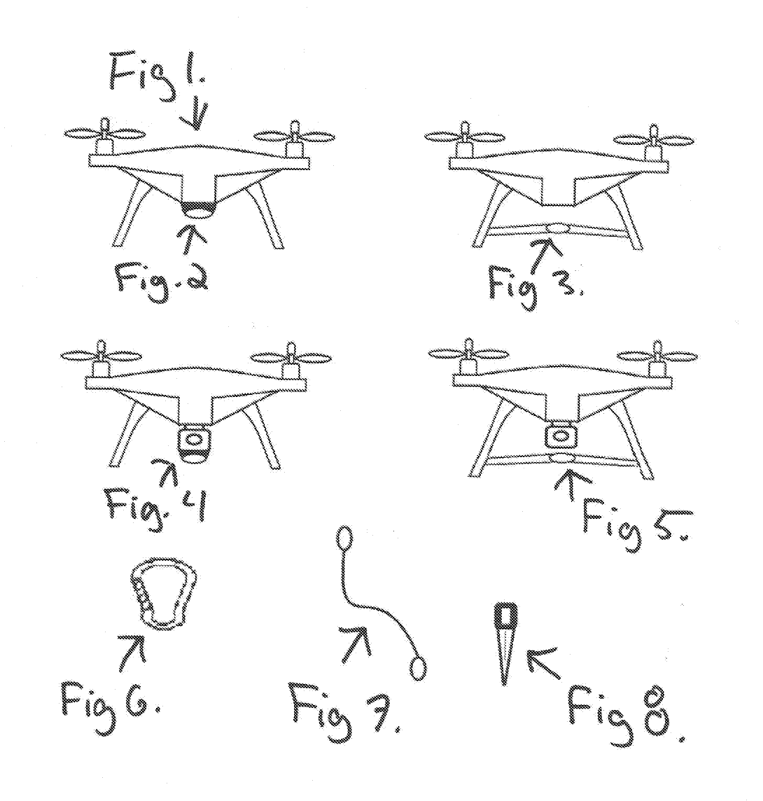

FIG. 3: A bar with an eyelet between the legs of the UAV. In case were it is unfeasible for the manufacturer to mount and eyelet anchor to the UAV due to design and specifications, the bar can be used to have the same effect as the eyelet anchor in FIG. 1.

FIG. 4: An eyelet anchor attached to the bottom of the UAV's HD camera. In case where it is unfeasible for the manufacturer to mount an eyelet anchor to the bottom of the UAV and also unfeasible to have the eyelet bar, the eyelet anchor can then be mounted below the UVA's HD camera and have the same effect as in FIGS. 1 and 3.

FIG. 5: The bar with an eyelet between the legs of the UAV and under the HD camera. In case where it is unfeasible for the manufacturer to mount an eyelet anchor to the bottom of the UAV and also unfeasible to have the eyelet bar, the eyelet anchor can then be mounted below the UVA's HD camera and have the same effect as in FIGS. 1, 3 and 4.

FIG. 6: A carabiner clip is a device that can clip to an open position and a closed to a locked position. For the present invention, the carabiner clip is used to lock in one loop from the double looped rope and then onto the eyelet anchor mounted to the UAV. The carabiner clip can also clip to the eyelet stake or onto anything that can anchor the UVA properly such as; a fence, heavy chair etc.

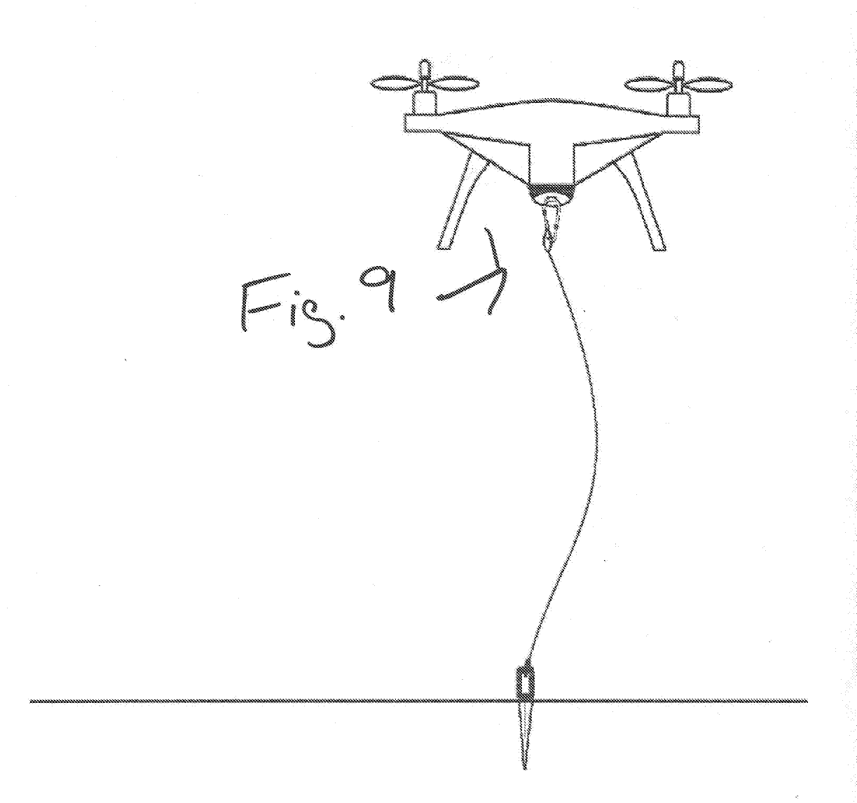

FIG. 7: A double looped rope. The rope in the present invention is used to anchor the UAV to the carabiner clip in the close position and then fastened into the eyelet stake.

FIG. 8: The eyelet stake in the present invention is used to anchor the rope into the ground. There are limitless possibilities for the design of the eyelet stake and the one depicted in the drawings is just one possibility. Once the stake is planted in the ground, the user has to gently pull and tug on the stake to test the firmness of the plant so that the UAV will not fly away with the eyelet stake.

FIG. 9: The UAV Anchoring System complete and staked into the ground depicted by the line in the drawing on page 2 of the drawings. The carabiner clip is in the locked position with one loop of the rope and the eyelet anchor. Loop #2 is fastened to the eyelet stake and the eyelet stake is planted firmly into the ground.

1. The eyelet anchor on the UAV is used to anchor the UAV to the ground. It is comprised of an eyelet anchor that's attached to the UAV, a carabiner clip, a double looped rope and an eyelet stake.

2. The anchoring system is primarily for beginners who are new to flying UAVs. This includes the commercial industry where employees are required to fly a UAV. Anchoring the UAV will allow the user to safely fly an UAV and not have the UAV fly away rapidly and crash from a high altitude and also to prevent the UAV from hitting any type of obstruction including nearby people. Thus, this system will allow the user to learn quicker or for intermediate to expert flyers, this anchoring system can be used to better learn how to safely fly a UVA in any type of undesirable weather such as high winds.

3. This system can also benefit expert flyers as they will usually not allow a beginner to fly their UAVs as they will fear crashing and damaging of their UAV.

4. Parents can also greatly benefit from this system and they can anchor the UAV to the ground and leave their children unsupervised with the peace of mind that they will not fly the UAV into other people, objects, traffic, or people's property etc.

5. This system is also beneficiary as users do not have to travel to a large field to fly their UAV. They can anchor their UAV's in their backyards, front yards, the closest public park or any small area where the user can judge is open enough to fly the UAV.

6. Adjusting the length of the rope when it is anchored is crucial for the functionality of the system. The user must adjust the rope by shortening it and then tying a knot in the eyelet of the stake or the shaft of the stake if the stake does not have an eyelet. When the UAV is anchored, the user must do a 360 degree walk around of the flying area to see if the the UAV comes close to any objects or obstruction in the UAV's path. If it does, the user must shorten the rope, and redo the 360 degree walk around. Also, when flying UAV, the user must also stay clear from the UAV's flying path.

7. The eyelet anchor can molded to be part of the UAV itself or it can be a separate piece which can then be glued on to the UAV, screwed in or in any other possible way which will attach the eyelet anchor to the UAV.

8. Some UAVs have HD cameras mounted at the bottom and if the manufacturers deems it is feasible regarding space, camera functionality, manufacturing costs, etc. An eyelet anchor can also be mounted at the bottom of the HD camera.

9. For better functionality, the eyelet anchor should be positioned as center as possible underneath the UAV. Ex; if the eyelet anchor is positioned too much to the front, when the flying UAV extends the anchored rope to its maximum capacity, the flying device will flip forward and cause the flying device to crash. This scenario will also happen if the eyelet is positioned too far the right, left and back of the UAV.

10. The double looped rope. There is a loop at both ends of the rope which is there to facilitate the anchoring system. But, the double loop is not a necessity. It can be a normal rope with only 1 or even no loops at all, in that case, the user simply has to tie a knot to the eyelet anchor, carabiner clip, stake, or any object on the ground like a fence, deck, chair, etc.

11. The stake also has an eyelet where the rope can be looped on or tied on. In the case that there is no eyelet on the stake, the user can tied the rope to the shaft of the stake before the user puts the stake into the ground. The stake is not limited to one design, there can be multiple types of design for the stake as long the stake design is good enough to stay in the ground while the UAV is being flown. This will depend on length, width, etc.

12. The carabiner clip can used in multiple ways in this system. The user can clip onto the loop of the rope then clipped onto the eyelet anchor. Or vise versa, the user can clip onto the loop of the rope then onto the eyelet of the stake, if there is one. Also, the user can clip the carabiner clip onto any objects that can be used as an anchor such as; a deck, heavy chair, fence, etc.

13. The carabiner clip can also be used as a storing tool to conveniently store all parts of the anchoring system. In the open position, the user simply has to put both loops of the rope and the eyelet stake into the carabiner, then lock the carabiner clip. Then all the parts of the anchoring system is in one place and will not be separated.
